(19) United States
(12) Patent Application Publication
(10) Pub. No.: US 2022/0349069 A1
(43) Pub. Date: Nov. 3, 2022

(54) ARGON STRIPPING FROM WATER FOR HIGH PURITY HYDROGEN AND OXYGEN PRODUCTION

(71) Applicants: Messer Industries USA, Inc., Bridgewater, NJ (US); Messer SE & Co KGaA, Bad Soden am Taunus (DE)

(72) Inventors: Marco Golbach, Bad Soden am Taunus (DE); Leeann Greene, Bridgewater, NJ (US); Alexander Schlotmann, Krefeld (DE)

(73) Assignees: Messer Industries USA, Inc., Bridgewater, NJ (US); Messer SE & Co KGaA, Bad Soden am Taunus (DE)

(21) Appl. No.: 17/543,776

(22) Filed: Dec. 7, 2021

Related U.S. Application Data
(60) Provisional application No. 63/180,707, filed on Apr. 28, 2021.

(51) Int. Cl. C25B 1/50; C25B 1/044; C25B 15/08

(52) U.S. Cl. CPC C25B 1/50; C25B 1/044; C25B 15/083; C25B 15/085

(57) ABSTRACT

A method for producing ultra-pure hydrogen is provided which includes heating water for stripping argon from the water; and separating the argon-stripped water into an oxygen stream and a hydrogen stream, wherein the hydrogen stream includes an ultra-pure hydrogen stream. A related system for producing an ultra-pure hydrogen stream is also provided which includes a container in which argon is stripped from water by steam; at least one electrolyzer cell to be contacted by the argon-stripped water; wherein the at least one electrolyzer cell provides an oxygen stream and a hydrogen stream with an argon content less than 0.25 ppm.

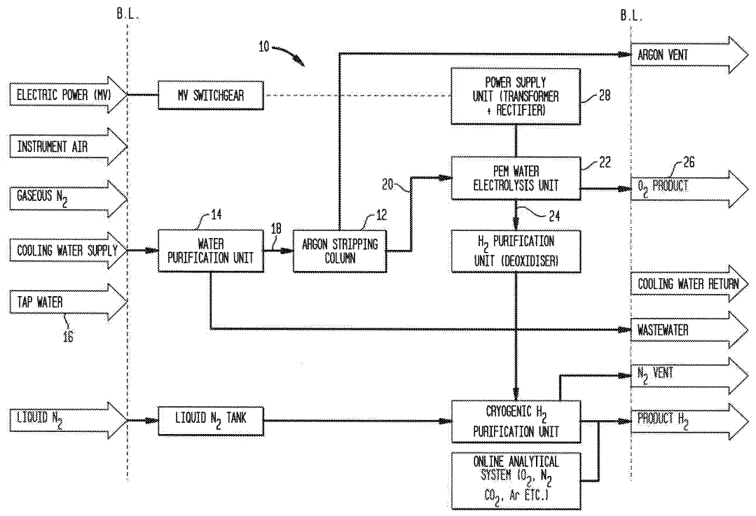

### BACKGROUND OF THE INVENTION

The present embodiments relate to purifying water for use in electronics applications and in particular to apparatus and methods for removing argon (Ar) from the water used for hydrogen (H₂) and oxygen (O₂) production.

### SUMMARY OF THE INVENTION

The electronics, semiconductor and computer industries, to name only a few, use high purity or “ultra-pure” hydrogen (H₂) for various component fabrications and processes. Unfortunately, argon (Ar), which is present in the feedwater, ends up being present in the hydrogen product when the water (H₂O) is separated into hydrogen and oxygen in an electrolysis unit. The presence of argon in the hydrogen is detrimental to the effectiveness and purity level of the hydrogen and accordingly, the argon must be separated or removed from the hydrogen for the hydrogen to be of use for certain applications. The absence of a sufficient amount of argon from the hydrogen can result in an ultra-pure hydrogen. Ultra-pure hydrogen is recognized as hydrogen with not more than 100 ppb of argon in the hydrogen.

Known methods to remove argon occur downstream of the electrolysis unit and primarily include cryogenic adsorption systems and processes. Such known apparatus and methods remove argon from the hydrogen to produce ultra-pure hydrogen by first introducing water to electrolyzer cells to separate oxygen (O₂) and hydrogen molecules in the water, and then further processing the separated hydrogen stream thereafter to remove the argon therein. The downstream removal of the argon-laden hydrogen from the electrolyzer cells is expensive and time consuming. These known systems and processes to remove the argon include large downstream cryogenic purification systems to purify the hydrogen, and such systems are complex and expensive to construct and to operate.

It would therefore be desirable and advantageous to eliminate the argon removal downstream from the electrolyzer cells.

### BRIEF DESCRIPTION OF THE DRAWING

For a more complete understanding of the present invention, reference may be had to the following description of exemplary embodiments considered in connection with the accompanying drawing FIGURE, of which.

The FIGURE shows a schematic view of apparatus, system and method embodiments to strip or remove argon from water according to the present invention.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

The present inventive embodiments remove argon from feed water by stripping-out the argon from the feed water upstream of the electrolyzer cells. The result is that both a stream of hydrogen and a stream of oxygen are created each of which if free of argon.

In general, the present inventive embodiments reduce if not eliminate argon content in hydrogen so that the hydrogen can be characterized as ultra-pure hydrogen for subsequent use. Argon stripping is a physical separation process, wherein argon is removed from a liquid water stream by a water vapor stream. The liquid water and vapor streams can have co-current or countercurrent flows. The argon stripping is performed in either a plate column or in a packed column. This is accomplished by heating feed water so that the water boils and the argon is accordingly stripped from the heated water. The argon-stripped water is then delivered to electrolyzer cells which split the water into an oxygen stream and a hydrogen stream, with both the oxygen and hydrogen streams having a reduced argon content, if any, thus qualifying the hydrogen and the oxygen as an ultra-pure hydrogen stream and an ultra-pure oxygen stream.

The argon content in the ultra-pure hydrogen and ultra-pure oxygen streams provided by the present embodiments is in the range of 100 ppb to 10 ppb argon.

More specifically and referring to the FIGURE, system and apparatus embodiments for carrying out the method embodiments of the present invention are shown generally at 10 for which an argon stripping column 12 is provided. A water purification unit 14 positioned upstream of and in fluid communication with the column 12 receives water 16, such as for example tap water. The purification unit 14 removes minerals, contaminants and other particulate matter from the tap water 16 to produce demineralized water.

Thereafter, the argon-stripped water is delivered from the stripping column 12 through a pipe 20 or other conduit to a PEM water electrolysis unit 22 to split the water into a hydrogen (H₂) stream 24 and an oxygen (O₂) stream 26. A power supply 28 provides the electrical power for the PEM water electrolysis unit 22. Water exiting the argon stripping column 12 is reduced in argon content. Depending upon the argon stripping operation, the water exiting the stripping column 12 can contain less than 0.25 ppm Ar or for certain operations and subsequent applications less than 10 ppb Ar. The system and method of the FIGURE show the inventive embodiments for use with steam heat to boil the water in the argon stripping unit 12 to strip the argon from the water.

As the FIGURE shows, the ultra-pure hydrogen stream 24 can be subjected to further processing according to the present inventive embodiments.

In certain embodiments there is provided a method for producing ultra-pure hydrogen which includes heating water for stripping argon from the water; and separating the argon-stripped water into an oxygen stream and a hydrogen stream, wherein the hydrogen stream comprises an ultra-pure hydrogen stream.

In certain embodiments the oxygen stream comprises and ultra-pure oxygen stream.

In certain embodiments the heating is from a heat source selected from the group consisting of steam, and an electric heater.

In certain embodiments the argon-stripped water comprises an argon content not exceeding 0.25 ppm.

In certain embodiments the argon-stripped water comprises an argon content not exceeding 100 ppb.

In certain embodiments the argon-stripped water comprises an argon content not exceeding 10 ppb.

In certain embodiments the stripping argon occurs upstream of electrolyzer cells.

In certain embodiments the separating comprises delivering the argon-stripped water to electrolyzer cells.

In certain embodiments the method further includes purifying the ultra-pure hydrogen stream.

In certain embodiments the method further includes delivering the purified ultra-pure hydrogen stream to a cryogenic purification system.

In certain embodiments there is provided a method for stripping argon from hydrogen which includes heating water to strip argon from the water; providing argon-stripped water to at least one electrolyzer cell; and separating or splitting the argon-stripped water into an oxygen stream and a hydrogen stream, wherein the hydrogen stream comprises argon less than 0.25 ppm.

In certain embodiments there is provided a method for stripping argon from hydrogen which includes heating water to strip argon from the water; providing argon-stripped water to at least one electrolyzer cell; and separating or splitting the argon-stripped water into an oxygen stream and a hydrogen stream, wherein the hydrogen stream comprises argon less than 100 ppb.

In certain embodiments there is provided a method for stripping argon from hydrogen which includes heating water to strip argon from the water; providing argon-stripped water to at least one electrolyzer cell; and separating or splitting the argon-stripped water into an oxygen stream and a hydrogen stream, wherein the hydrogen stream comprises argon less than 10 ppb.

In certain embodiments there is provided a method of producing an argon depleted hydrogen stream which includes heating or boiling water for removing argon from the water, and electrolyzing the water for producing a hydrogen stream including argon less than 0.25 ppm.

In certain embodiments there is provided a method of producing an argon depleted hydrogen stream which includes heating or boiling water for removing argon from the water, and electrolyzing the water for producing a hydrogen stream including argon less than 100 ppb.

In certain embodiments there is provided a method of producing an argon depleted hydrogen stream which includes heating or boiling water for removing argon from the water, and electrolyzing the water for producing a hydrogen stream including argon less than 10 ppb.

In certain embodiments there is provided argon-depleted water electrolyzed for providing an ultra-pure oxygen stream and an ultra-pure hydrogen stream with argon content less than 0.25 ppm.

In certain embodiments there is provided a system for producing an ultra-pure hydrogen stream which includes a container in which argon is stripped from water by steam; at least one electrolyzer cell to be contacted by the argon-stripped water; wherein the at least one electrolyzer cell provides an oxygen stream and a hydrogen stream with an argon content less than 0.25 ppm.

In certain embodiments there is provided a method for stripping argon from oxygen which includes heating water to strip argon from the water; providing argon-stripped water to at least one electrolyzer cell; and separating or splitting the argon-stripped water into an oxygen stream and a hydrogen stream, wherein the oxygen stream comprises argon less than 0.25 ppm.

In certain embodiments there is provided a method for stripping argon from oxygen which includes heating water to strip argon from the water; providing argon-stripped water to at least one electrolyzer cell; and separating or splitting the argon-stripped water into an oxygen stream and a hydrogen stream, wherein the oxygen stream comprises argon less than 100 ppb.

In certain embodiments there is provided a method for stripping argon from oxygen which includes heating water to strip argon from the water; providing argon-stripped water to at least one electrolyzer cell; and separating or splitting the argon-stripped water into an oxygen stream and a hydrogen stream, wherein the oxygen stream comprises argon less than 10 ppb.

It will be understood that the embodiments described herein are merely exemplary, and that a person skilled in the art may make variations and modifications without departing from the spirit and scope of the invention. All such variations and modifications are intended to be included within the scope of the invention provided the appended claims. It is understood that the embodiments described above are not only in the alternative but can be combined.

What is claimed is:

1. A method for producing ultra-pure hydrogen, comprising:
heating water for stripping argon from the water; and
separating the argon-stripped water into an oxygen stream and a hydrogen stream, wherein the hydrogen stream comprises an ultra-pure hydrogen stream.

2. The method of claim 1, wherein the oxygen stream comprises an ultra-pure oxygen stream.

3. The method of claim 1, wherein the heating is from a heat source selected from the group consisting of steam, and an electric heater.

4. The method of claim 1, wherein the argon-stripped water comprises an argon content not exceeding 0.25 ppm.

5. The method of claim 1, wherein the argon-stripped water comprises an argon content not exceeding 100 ppb.

6. The method of claim 1, wherein the argon-stripped water comprises an argon content not exceeding 10 ppb.

7. The method of claim 1, wherein the stripping argon occurs upstream of electrolyzer cells.

8. The method of claim 1, wherein the separating comprises delivering the argon-stripped water to electrolyzer cells.

9. The method of claim 1, further comprising purifying the ultra-pure hydrogen stream.

10. The method of claim 9, further comprising delivering the purified ultra-pure hydrogen stream to a cryogenic purification system.

11. Argon-depleted water electrolyzed for providing an ultra-pure oxygen stream and an ultra-pure hydrogen stream with argon content less than 0.25 ppm.

12. A system for producing an ultra-pure hydrogen stream, comprising:
a container in which argon is stripped from water by steam;
at least one electrolyzer cell to be contacted by the argon-stripped water;
wherein the at least one electrolyzer cell provides an oxygen stream and a hydrogen stream with an argon content less than 0.25 ppm.

13. A method for stripping argon from oxygen, comprising:
heating water to strip argon from the water;
providing argon-stripped water to at least one electrolyzer cell; and
separating or splitting the argon-stripped water into an oxygen stream and a hydrogen stream, wherein the oxygen stream comprises argon in an amount less than 0.25 ppm, optionally in an amount less than 100 ppb, or optionally in an amount less than 10 ppb.
